(19) United States
(12) Patent Application Publication
(10) Pub. No.: US 2009/0103804 A1
(43) Pub. Date: Apr. 23, 2009

(54) METHOD FOR COLOR TRANSIENT IMPROVEMENT AND APPARATUS THEREOF

(76) Inventor: Hung-Shih Lin, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/875,953

(22) Filed: Oct. 22, 2007

(51) Int. Cl. G06K 9/00

(52) U.S. Cl. 382/167

(57) ABSTRACT

A method for color transient improvement includes generating an angle value according to an included angle of two color components in a specific color space domain, and generating a transient enhancement signal according to the angle value. Furthermore, a color transient improvement circuit is provided. The color transient improvement circuit includes an angle calculator for generating an angle value according to an included angle of two color components in a specific color space domain, and a processor coupled to the angle calculator for generating a transient enhancement signal according to the angle value.

### BACKGROUND OF THE INVENTION

1. Field of the Invention

The present invention relates to image processing, and more particularly, to a method for color transient improvement and apparatus thereof.

2. Description of the Prior Art

In general, approaches of color transient enhancement all need to consider two color vectors (i.e. color components) simultaneously (for example, U/V or Cb/Cr), but the change of color is usually different from changes of the displayed two color vectors. Accordingly, when processing the color edge using two color vectors, the processing complexity is much higher than that of processing the luminance edge. Additionally, the final displayed result of the color transient enhancement is not sharper than that of the luminance transient improvement.

Please refer to FIG. 1. FIG. 1 is a block diagram of a prior art color transient enhancement circuit. As shown in FIG. 1, the processor 100 must receive two signals S1 and S2 for color transient enhancement, and then generate two enhanced signals S1′ and S2′, respectively. But it is complex to process the two signals S1 and S2 for color transient enhancement. Therefore, a novel method of color transient improvement is required to simplify color transient enhancement and shorten the processing time of the color transient improvement.

### SUMMARY OF THE INVENTION

It is therefore one of the objectives of the claimed invention to provide a method for color transient improvement and apparatus thereof, to solve the above-mentioned problems and enhance image quality.

According to one embodiment of the claimed invention, a method for color transient improvement is provided. The method comprises: generating an angle value according to an included angle of two color components in a specific color space domain; and generating a transient enhancement signal according to the angle value.

According to another embodiment of the present invention, a color transient improvement circuit is provided. The color transient improvement circuit comprises an angle calculator for generating an angle value according to an included angle of two color components in a specific color space domain, and a processor coupled to the angle calculator for generating a transient enhancement signal according to the angle value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a prior art color transient enhancement circuit.

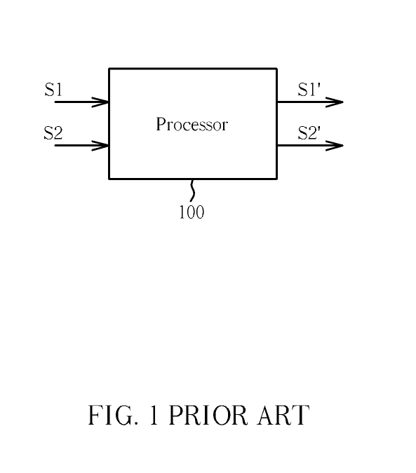

FIG. 2 is a flowchart illustrating a method for color transient improvement according to an embodiment of the present invention.

FIG. 3 is a diagram illustrating a color transient improvement circuit according to an embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

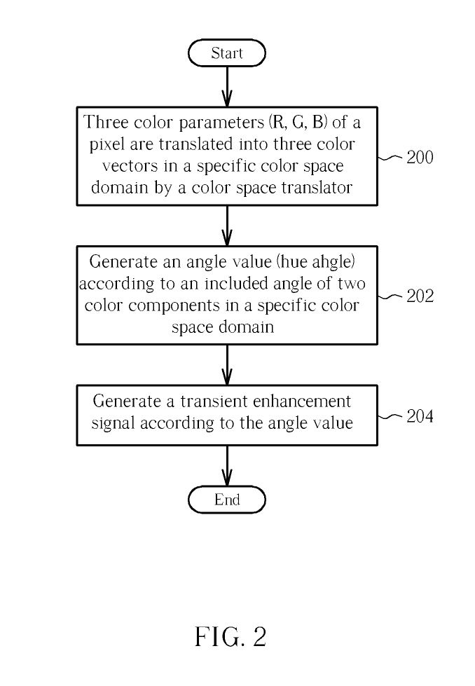

Please refer to FIG. 2. FIG. 2 is a flowchart illustrating a method for color transient improvement according to an exemplary embodiment of the present invention. As shown in FIG. 2, in Step 200, three color parameters (R, G, B) of a pixel are translated into three color vectors (e.g., (Y, U, V) or (Y, Cb, Cr)) in a specific color space domain by a color space translator. Then, in Step 202, an angle value is generated (for example, hue angle), according to an included angle of two color components in the specific color space domain, wherein the two color components may be the (U, V) or (Cb, Cr) of chrominance vectors, and the specific color space domain may be the YCbCr domain or the YUV domain. In Step 204, a processor generates a transient enhancement signal according to the angle value. In other words, the processor utilizes a transient function to generate the transient enhancement signal according to the angle value only. In this embodiment, the transient function may be (but is not limited to) a one-dimensional (1D) sharpness enhancement function for chroma (chrominance) transient improvement function (CTI), a two-dimensional (2D) sharpness enhancement function for chroma (chrominance) transient improvement function (CTI), a three-dimensional (3D) sharpness enhancement function for chroma (chrominance) transient improvement function (CTI), or even a luminance transient improvement (LTI).

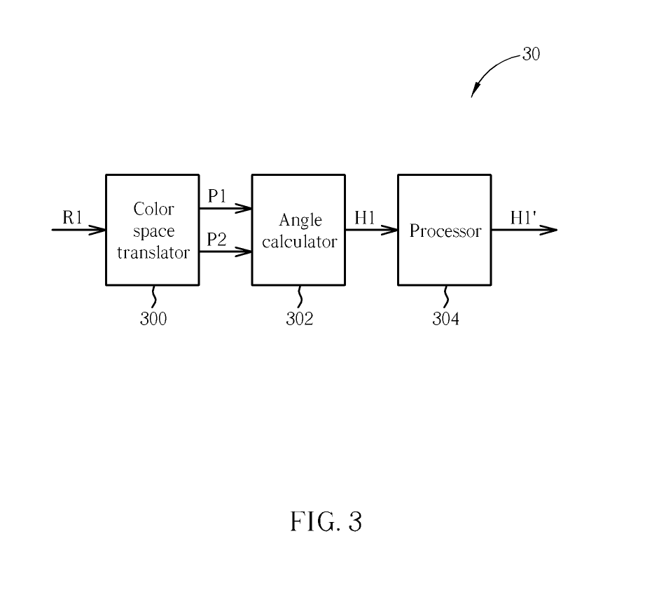

Please refer to FIG. 2 in conjunction with FIG. 3. FIG. 3 is a diagram illustrating a color transient improvement circuit 30 according to an embodiment of the present invention. As shown in FIG. 3, the color transient improvement circuit 30 comprises a color space translator 300 configured for translating a pixel R1 to color vectors in a specific color space domain, an angle calculator 302 configured for generating an angle value H1 according to an included angle of two color components P1 and P2 in the specific color space domain, and a processor 304 coupled to the angle calculator 302 for generating a transient enhancement signal H1′ according to the received angle value H1. In this embodiment, the specific color space domain is a YUV or YCbCr color space domain, and the color components are chrominance vectors. However, it should be noted that these are for illustrative purposes only, and are not meant to be limitations of the present invention. The color space translator 300 receives the pixel R1 with RGB format and translates the pixel R1 to other three chrominance vectors according to the specific color space domain, for example, YUV or YcbCr color space domain.

Next, the angle calculator 302 receives the two color components P1 and P2 representing the two chrominance vectors (U, V) or (Cb, Cr) from the color space translator 300, and calculates the included angle of two chrominance vectors in the specific color space domain. In this embodiment, the included angle is a hue angle. In addition, the angle calculator 302 generates the angle value H1. Then, the processor 304 generates a transient enhancement signal H1′ according to the angle value H1. The processor 304 performs one of the one-dimensional (1D) sharpness enhancement function for chroma (chrominance) transient improvement function, the two-dimensional (2D) sharpness enhancement function for chroma (chrominance) transient improvement function, the three-dimensional (3D) sharpness enhancement function for chroma (chrominance) transient improvement function, and the luminance transient improvement (LTI) function. As a result, the transient enhancement signal H1′ may enhance the sharpness of color edges more than the prior art means. It should be noted that only one parameter, the angle value H1, is fed into the following processor 304.

Similarly, as shown in FIG. 3, the processor 304 of the color transient improvement circuit 30 also utilizes a multiple-dimensional sharpness enhancement function for chroma (chrominance) transient improvement function to generate the transient enhancement signal.

It should be noted that the method for color transient improvement disclosed by the present invention is also applied in other pixels, and the other pixels also utilize the steps of FIG. 2 repeatedly to generate their respective transient enhancement signals.

It should be noted that the prior art utilizes two color vectors—for example (U, V) or (Cb, Cr)—for color transient enhancement, but the color transient improvement disclosed by the present invention utilizes one vector (i.e., hue angle) for color transient enhancement in one of the aforementioned one-dimensional (1D) sharpness enhancement function for chroma (chrominance) transient improvement function, two-dimensional (2D) sharpness enhancement function for chroma (chrominance) transient improvement function, three-dimensional (3D) sharpness enhancement function for chroma (chrominance) transient improvement function, and luminance transient improvement (LTI) function.

Please note that the aforementioned one-dimensional (1D) sharpness enhancement function for chroma (chrominance) transient improvement function, two-dimensional (2D) sharpness enhancement function for chroma (chrominance) transient improvement function, three-dimensional (3D) sharpness enhancement function for chroma (chrominance) transient improvement function, and luminance transient improvement (LTI) function are well known in the art, and since a skilled person can readily appreciate the operations and architectures of the aforementioned functions, further descriptions are omitted here for the sake of brevity.

In conclusion, the present invention is utilized to solve disadvantages of the prior art. The color transient improvement disclosed by the present invention generates an included angle of two color components Cb and Cr in a specific color space domain (for example, YCbCr domain), wherein the included angle is a hue angle. As a result, the color transient improvement disclosed by the present invention only processes one variable (i.e. the hue angle) and is seriously different from the prior art. As a result, the representation of color change is equivalent to the angle change of the hue angle. Accordingly, the color transient improvement disclosed by the present invention only performs enhancement of the hue angle transient for sharpness of the hue angle change. More particularly, the color edge of the color transient is sharper than the prior art. On the other hand, the color transient improvement disclosed by the present invention is not only utilized in the chroma (chrominance) transient improvement (CTI) function or luminance transient improvement (LTI) function, but also in other color transient enhancement (improvement) functions. Therefore, the color transient improvement disclosed by the present invention makes the frames have further depth of field.

Those skilled in the art will readily observe that numerous modifications and alterations of the device and method may be made while retaining the teachings of the invention.

What is claimed is:

1. A method for color transient improvement, comprising:
generating an angle value according to an included angle of two color components in a specific color space domain; and
generating a transient enhancement signal according to the angle value.

2. The method of claim 1, wherein the specific color space domain is a YUV or YCbCr color space domain, and the color components are chrominance vectors.

3. The method of claim 1, wherein the step of generating the transient enhancement signal comprises:
utilizing a transient function to generate the transient enhancement signal according to the angle value only.

4. The method of claim 3, wherein the transient function is a chroma (chrominance) transient improvement (CTI) function.

5. The method of claim 4, wherein the chroma transient improvement function is a one-dimensional (1D) sharpness enhancement function.

6. The method of claim 4, wherein the chroma transient improvement function is a two-dimensional (2D) sharpness enhancement function.

7. The method of claim 4, wherein the chroma transient improvement function is a three-dimensional (3D) sharpness enhancement function.

8. The method of claim 3, wherein the transient function is a luminance transient improvement (LTI) function.

9. A color transient improvement circuit, comprising:
an angle calculator, for generating an angle value according to an included angle of two color components in a specific color space domain; and
a processor, coupled to the angle calculator, for generating a transient enhancement signal according to the angle value.

10. The color transient improvement circuit of claim 8, wherein the specific color space domain is a YUV or YCbCr color space domain, and the color components are chrominance vectors.

11. The color transient improvement circuit of claim 8, wherein the processor utilizes a transient function to generate the transient enhancement signal according to the angle value only.

12. The color transient improvement circuit of claim 10, wherein the transient function is a chroma (chrominance) transient improvement (CTI) function.

13. The color transient improvement circuit of claim 11, wherein the chroma transient improvement function is a one-dimensional (1D) sharpness enhancement function.

14. The color transient improvement circuit of claim 11, wherein the chroma transient improvement function is a two-dimensional (2D) sharpness enhancement function.

15. The color transient improvement circuit of claim 11, wherein the chroma transient improvement function is a three-dimensional (3D) sharpness enhancement function.

16. The color transient improvement circuit of claim 10, wherein the transient function is a luminance transient improvement (LTI) function.
